(19) United States
(12) Patent Application Publication
(10) Pub. No.: US 2003/0097428 A1
(43) Pub. Date: May 22, 2003

(54) Internet server appliance platform with flexible integrated suite of server resources and content delivery capabilities supporting continuous data flow demands and bursty demands

(76) Inventors: Kambiz Afkhami, Richardson, TX (US); Clyde Shavers, Richardson, TX (US); Kelly Scott Campbell, Richardson, TX (US); Edgar Lawrence Read, Plano, TX (US)

Correspondence Address: Robert H. Frantz, P.O. Box 23324, Oklahoma City, OK, 73123, US

(21) Appl. No.: 10/014,275

(22) Filed: Oct. 26, 2001

(51) Int. Cl. G06F 15/167

(52) U.S. Cl. 709/220; 709/226; 709/214

(57) ABSTRACT

A horizontally scalable arrangement of computing and storage resources, including interconnections and interoperations, allowing configuration of various ratios of server capability to storage capability through a flexible and reconfigurable blade organization. External data communications are interfaced to two separate internal communications networks through a fixed set of switching resources, the switching resources being independent of the server and storage blades, one internal communications network for data flow to and from storage elements, and another internal network for data flow to and from server elements. Both internal networks are used for data flow between server and storage elements. The integrated switches reduce the number of cables in the system by providing aggregation and distribution of data. Signal processing resources are distributed with each server element, allowing efficient deployment of Internet applications without the need for specialized signal processing server platforms such as voice recognition servers, video compression servers, etc.

### TECHNICAL FIELD OF THE INVENTION

This invention relates to the fields of servers for use in networked and distributed computing environments, such as the Internet or intranets, and especially to those environments in which real time signal processing such as video and/or audio processing is required.

### CROSS-REFERENCE TO RELATED APPLICATIONS

Not applicable.

### FEDERALLY SPONSORED RESEARCH AND DEVELOPMENT STATEMENT

This invention was not developed in conjunction with any Federally sponsored contract.

### MICROFICHE APPENDIX

Not applicable.

### INCORPORATION BY REFERENCE

Not Applicable.

### BACKGROUND OF THE INVENTION

Traditionally, market spaces for telecommunications and networked computing equipment have been fairly distinct, each having it's own set of standards, requirements, and de facto conventions. Typically, a company which provides networked computing services such as web site hosting, content management, routing, etc., have constructed facilities having a plurality of computers such as high-end IBM-compatible personal computers or enterprise-class computers. These systems may be internetworked with each other via common computer network technologies such as Ethernet links. Eventually, somewhere in the configuration, there is a bridge or an access device which provides an interface between local data networks and a telecommunications network, such as a DS3 to Ethernet bridge.

The physical environment in which networked computing equipment is housed is usually very “computer” oriented, wherein the systems employed must be completely shut down for maintenance or service such as replacing a circuit card or performing loading of software. Most of these systems provide no redundancy within the computers themselves, so redundancy must be achieved by having duplicate computing units interconnected to the local data networks. To switch over from use of one computer to another, a router change is made such that all new “sessions” of applications are directed towards the back up computer, which eventually frees up the primary computer so that it can be shut down and serviced.

In the telecommunications environment, though, it has typically not been acceptable for switching equipment to have to be taken completely off line for maintenance or servicing. As such, the form factor of racks, shelves, and circuit cards have evolved to allow hot swapping of circuit cards and automatic switch over to redundant or back up resources. Many telecommunications switching systems allow for on-line upgrades and reconfiguration of resources, such as adding additional ports or integrating a new communication link or protocol—all done while normal operations continue. Most telecommunications systems run proprietary operating systems and do not allow for common applications programs, such as a Hyper Text Transfer Protocol server program, to be executed on the switching equipment.

Computer-based telecommunications switches have enjoyed minimal success as they typically cannot meet the stringent maintainability and availability requirements of the telecommunications environment. So, the traditional arrangement of equipment for Internet and network computing services companies is to provide two sets of equipment—telecom and computing—each in it's own environment with it's own advantages and limitations. This is expensive and in many cases unnecessarily bulky, but there is really no better option.

These companies also find themselves bringing new applications online often, upgrading other applications, and removing yet other applications, on a daily or even hourly basis. As these changes are made to the use of the installed computer and telecommunications equipment, it drives dramatically different maintenance operations.

For example, consider a situation where a computing system is “front-ended” by a DS3 bridge to the Internet, and all the computing system's processing bandwidth, memory and hard disk drive are currently consumed by the applications running on the system. Now consider that one of the applications is under utilized, so it can be reduced to handle fewer concurrent sessions, making some processing bandwidth, memory and hard disk space available on the computing system. And, a new business opportunity is available to deploy a new application which can effectively execute in the available processing bandwidth, but the new application requires more hard disk drive space and communications bandwidth than was freed up by the reduction of the other application.

To solve the communications bandwidth problem, a technician may simply install another DS3 card in the bridge or “switch” system and provision that bandwidth to be available to the computing system.

However, in contrast, to upgrade the computing system's hard disk drive and possibly its network interface card (NIC), the entire computing system must be powered down (rendering all other applications off line as well), an additional hard drive installed, possibly a replacement or additional NIC installed, and the system brought back online. Some software configuration work may be necessary before all of the old plus the new applications can be restarted. During this time, another redundant system may have been handling the demands of the system, so there may have to be some additional work on a router to re-route “traffic” back to the primary system.

This process can take minutes, hours or even days, depending on the magnitude and complexity of the changes. Further, given the reliability of some computer operating systems, the process may be very indeterministic such that there may never be 100% certainty that the new configuration of the computing system will actually come back on line.

A similar process is required when a computer system component or element fails. For example, if a NIC card in a computer system fails, the system must be completely powered down so that the NIC card can be replaced.

This causes many networked computing service companies and departments within companies to maintain entire systems as redundant backup systems, which is unnecessarily expensive. Further, it causes intolerable delays and labor to maintain and manage these systems, as two sets of skills are necessary to work on the equipment (familiarity with telecom equipment and familiarity with the computing equipment) which usually leads to retaining two sets of staff members with two specialties. Additionally, it may cause uncontrollable and unpredictable service delivery problems and “outages” when maintenance and service operations are undertaken.

Therefore, there is a need in the art for a system and method which addresses these combined needs, including providing “telco-like” maintainability, reliability and availability with online upgradability, and “computer-like” functionality including ability to execute common computer operating systems and application programs.

Yet another trend in the networked computing environment is a shift of traditionally telecommunications processing functions to web servers. For example, just a few years ago, only telecommunications switches and equipment were required to be able to compress and expand audio or video signals for multiplexing and demultiplexing the signals during transmission. These systems typically are provided with highly specialized signal processing hardware and software depending on the intended application.

However, many web sites now offer “video on demand” and “Internet phone” or “Internet video conferencing” services. New services related to the expanding base of wireless web users who use networked personal digital assistants (PDA's) and web-enabled wireless phones include voice-navigation of web pages, voice playback of web pages, and realtime audio and video signal compression and expansion. This requires the computer systems to provide voice recognition, text-to-speech synthesis, video “CODECS”, etc., in software or hardware. Again, as the applications being run on a server computer are changed or upgraded, these special software and hardware components may have to be replaced, requiring the entire computer system to be taken off line.

Therefore, there is an additional need in the art for this new system and method to provide scalable, allocatable and maintainable signal processing resources for use by application programs.

### SUMMARY OF THE INVENTION

The present invention provides a method and system for arranging computing components and resources, including interconnections and interoperations, in a horizontally scalable manner to realize an Internet Server Appliance Platform (ISAP). The integrated suite of server resources and content delivery capabilities can be installed in various ratios of server (e.g. processor) capability to storage capability through a flexible and reconfigurable blade organization.

External data communications are interfaced to two separate internal communications networks through a fixed set of switching resources, the switching resources being independent of the server and storage blades. One internal communications network is reserved for data flow to and from storage elements, while the other internal communications network is reserved for data flow to and from server elements, with a built-in switch for aggregation and distribution of data.

This allows the platform to be utilized in a wide variety of applications in a networked computing environment such as the Internet, while providing “telco-like” reliability and maintainability. Additionally, signal processing resources are distributed to be locally available with each processing element or server element, to enable efficient deployment of modern Internet applications without the need for specialized signal processing server platforms such as voice recognition servers, video compression servers, and the like. The architecture also allows applications to be handled with equal efficiency, whether they exhibit continuous data flow demands or bursty demands.

### BRIEF DESCRIPTION OF THE DRAWINGS

The figures presented herein when taken in conjunction with the disclosure form a complete description of the invention.

FIG. 1 shows the overall architecture of the present invention in which multiple systems are networked to form a larger virtual system.

FIGS. 2a and 2b illustrate the mechanical and physical structures of this system rack.

FIGS. 3a and 3b provide a detailed depiction of the mechanical and physical arrangement of the shelf components.

FIG. 4 illustrates the architecture of an Internet Server Appliance Platform (ISAP) shelf in detail.

FIG. 5 shows the server module (processor blade) architecture.

FIG. 6 provides details of the administration module architecture.

FIG. 7 sets forth details of the preferred embodiment of the Ethernet switch on the administration module.

FIG. 8 shows details of the storage blade design.

### DETAILED DESCRIPTION OF THE INVENTION

The present invention provides the system and method of a virtual application server for use in networked computing and distributed computing environments such as the Internet or corporate intranets. According to our definition, a virtual server is a server which provides dynamic resource allocation for the simultaneous execution of a plurality of computer application programs which serve client computers via a computer network such as the Internet or an Intranet.

In such a virtual server, system resources including processing bandwidth, volatile memory and persistent data storage, as well as communications bandwidth may be dynamically assigned, deallocated, consolidated and divided based on real-time requirements of concurrently executing application programs to meet changing client needs. Additionally, the present invention provides distributed signal processing functionality and hardware acceleration for processing of signal types such as video and companding, error detection and correction, voice recognition, text to speech synthesis and speech to text conversion. Table 1 summarizes many of the applications for which the present invention may be employed given proper application software and configuration of storage blades, server blades, and connectivity.

TABLE 1
ISAP Potential Applications

| Application | Application Description |
|---|---|
| Web Server | A web server is an application fielded by a web site |
| | that provides web pages to requesting web clients. |
| Application Server | An application server is used to isolate an enterprise |
| | business logic in a distributed, multi-tier |
| | architecture. It is typically used as the second tier |
| | (middle) in a three-tier architecture where the first |
| | tier (front-end) is the web server and the third tier |
| | (back-end) is the database server and legacy |
| | applications. |
| Cache Server | A cache server is used to cache frequently |
| | requested web pages and files from Internet and/or |
| | Intranet servers closer to the requesting users. |
| Proxy Server | A proxy server is used to intercept and manage user |
| | Internet requests. |
| Firewall | A firewall is used to protect the resources of a |
| | private network from users on other networks (i.e., |
| | the Internet) that are connected to it. |
| Router | A router is used to interconnect two (or more) |
| | networks and to determine where to forward IP |
| | packets to get them closer to their final destinations. |
| Load Balancer | A load balancer is a router that distributes server |
| | workload among the servers in a cluster according |
| | to a preset algorithm. Load balancers direct client |
| | traffic to the servers according to their capabilities |
| | and current status to smooth server loading and |
| | improve performance. They also provide fault |
| | tolerance by not directing client traffic to any server |
| | in the cluster that is found to be out of service or |
| | underperforming. |
| Secure Sockets | The SSL Acceleration application will offload SSL |
| Layer Acceleration | transaction processing from the PowerPC main |
| | processing engine to its Altivec vector engine. This |
| | will speed up SSL transactions while allowing the |
| | main engine to continue to process other requests. |
| Voice Portal Server | A voice portal allows a user to interact with a web |
| | site via a telephone to gain access to information |
| | contained on that web site, such as stock quotes, |
| | order status, or account balances. A voice portal is |
| | the result of melding Interactive Voice Response |
| | (IVR) technology with traditional web site |
| | technology. |
| Database (DB) | Databases provide a standard means to store and |
| Server | organize data so that it can be easily accessed, |
| | updated, and managed. |
| DNS Server | A Domain Name System (DNS) server is used to |
| | resolve domain names into IP addresses. |
| DHCP Server | The Dynamic Host Configuration Protocol (DHCP) |
| | server application automates the assignment of IP |
| | addresses to machines in a network. Each machine |
| | that is connected to the Internet and uses the |
| | TCP/IP protocol requires a unique IP address. |
| | DHCP provides a means for machines to “lease” an |
| | IP address from a centralized DHCP server. |
| Email Server | The Electronic Mail (Email) server handles the |
| | routing and transport of email messages. |
| FTP Server | The File Transfer Protocol (FTP) server application |
| | is used to exchange files between computers on the |
| | Internet. It is commonly used to download files |
| | from servers and to publish web pages to web sites. |
| NNTP Server | The Network News Transfer Protocol (NNTP) |
| | server application is used to distribute Usenet |
| | newsgroup traffic. A newsgroup is a discussion |
| | group about a particular subject that consists of |
| | messages sent to the group by the users of the |
| | group. The messages are distributed through |
| | Usenet, which is a network of news discussion |
| | groups. |
| NTP Server | The Network Time Protocol (NTP) is used to |
| | synchronize computer clocks in a network. |

Unlike traditional server architectures which associate a processor complex with a set of persistent storage devices such as hard disk drives, and a set of input and output links such as a set of Ethernet links, the system and method of the invention provides a pool of resources divided into groups as follows:

(a) servers (processors);

(b) storage (hard disk drive, micro-drives, flash memory, etc.); and

(c) communications bandwidth (links);

In this inventive arrangement, processing resources and storage resources are decoupled from each other, both physically and logically. Additionally, a switching fabric is built into the architecture of the system. In this modular organization, a very wide variety of configurations of the Internet Server Appliance Platform (ISAP) system may be realized by installing more or less of each resource type, and soft reconfiguring the system to utilize those resources per the requirements of specific application programs.

The cumulative advantages of the invention are that applications may be hosted in less physical space, with a higher degree of reliability, with less associated cabling and connectors, and significantly reduced costs especially in the areas of training, stocking of spares, etc.

The system electronic hardware is organized to provide redundancy, ease-of-use, and compliance and compatibility with telecommunications as well as Internet computing standards. Ease-of-use is promoted through the provision of front access for all replaceable units such as server and storage blades, as well as front connectivity for all communications cables.

System management software provisions a set of resources for each application to be executed by the system according to user-defined criteria such as time, events, load level, etc. System management may be performed remotely or locally as it employs a Web based interface to the ISAP systems. System management software preferably employs distributed and object oriented techniques to allow it to be scalable and maintainable.

According to other objectives of the invention, the system method provides carrier-class reliability and availability for the entire system which is a standard requirement of telecommunications switching equipment, but has heretofore not been a requirement met by Internet server systems.

All of these features and aspects of the invention allow it to be employed in a diverse array of applications as previously discussed and summarized in Table 1. Server unit to storage unit ratios may be adjusted depending on the needs of each particular application. In some applications, a one-to-one (1:1) ratio of processors to storage units may be adopted. In a new paradigm available according to the invention, an N:1 ratio may just as easily be adopted, either during initial installation or during later system re-configuration. In a reverse configuration of 1:N processors to storage units, advanced network attached storage applications can be accommodated to eliminate access bottlenecks in a network.

As such, the system is designed to accommodate multiple possible upgrade migration paths, with a forward-looking architecture that avoids partial or total system obsolescence.

Horizontal scalability is provided by the system architecture in that multiple server blades may be installed to perform the same function or run the same application. As such, to increase the ability of the system to handle more sessions of a particular application, it must only be reconfigured to assign more processing resources to that application.

In yet another feature of the present invention which supports horizontal scalability, signal processing (“DSP”) capabilities and acceleration hardware are co-located with the processors (e.g. distributed across server blades) such that applications like secure socket layer (SSL), real-time signal compression, and mobile and wireless telephone applications can be efficiently hosted on the ISAP. Traditionally, telecom and Internet DSP processing functions have been centralized in specialized servers which support the application servers. Under such a traditional arrangement, in order to increase the level of service of a particular application, perhaps a voice-navigated web site using voice recognition, certain economies of scale required incremental increases in the DSP server resources to increase the voice recognition capabilities. With the arrangement of the invention, the needed DSP resources are scaled directly with the assigned application processor capabilities, which avoids these economy of scale incremental steps.

Due to the system's built-in switching fabric with integrated and scalable processing and storage facilities, considerable cable bulk is eliminated which is normally present in systems comprised of multiple racks and individual computing units. This reduces a typical cable harness diameter of 5.6 inches to approximately 1.5 inches for 200 server units. This reduces the cost of ownership of the system by increasing reliability, improving maintainability, and reducing sheer bulk and space requirements. Top Level Architecture

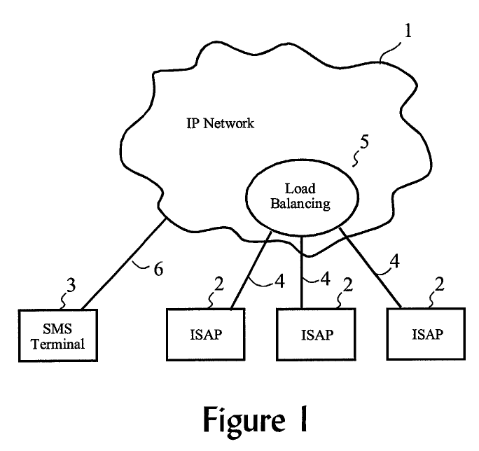

The top-level architecture of the system is shown in FIG. 1 in which multiple Internet Server Appliance Platforms (ISAPs) (2) are interconnected to each other using computer data networks (4), such as Gigabit Ethernet links (4) to an IP Network (1) such as the Internet or an intranet. Preferably, a network-based load balancing system (5) is also included to direct application demands to the ISAP (2) units according to a load plan. Load balancing systems are well-known in the art, as are Ethernet links and IP Networks.

Additionally, an administrative terminal running System Management Software (SMS) (3) is provided with a data communication facility (6) such as an Ethernet link to the computer network (1) such that it may communicate with, configure, and control the ISAP units (2), remotely or locally.

Mechanical and Physical Structures

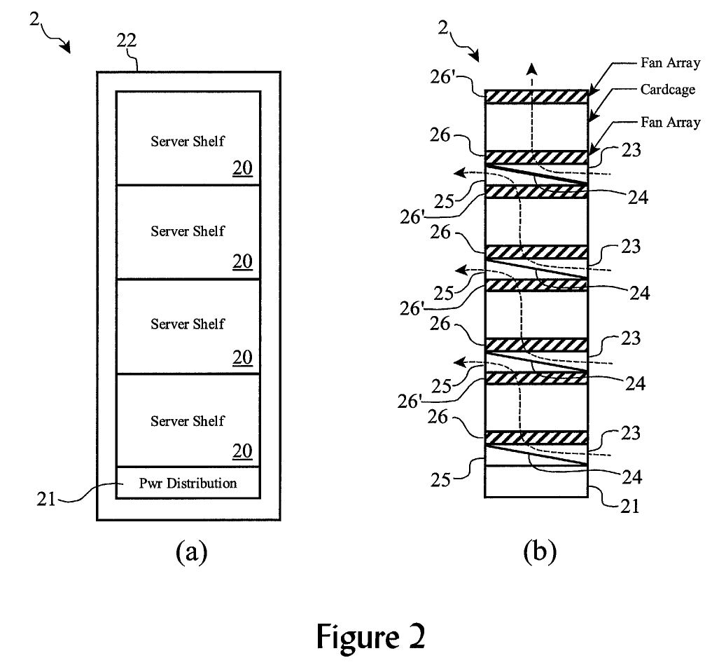

Prior to disclosing the electronic and software arrangements of the functionality of the ISAP, it will be useful to understand the mechanical organization of the ISAP units. Turning to FIGS. 2a and 2b, front and side views, respectively, are provided of the ISAP system (2) rack (22) and shelf (20) structures. An ISAP rack (22) according to the preferred embodiment houses a number of shelves (20), each shelf (20) having a height of 10 Rack Units (“RU”). A rack unit is defined as 1.75 inches according to industry convention for rack-mounted equipment. As such, four shelves (20) may be contained in a single 84-inch rack (22), including a power distribution unit (21).

Each shelf (20) is provided with an air flow intake (23) on the front side of the shelf (20), and an air flow outlet (25) on the back side of the shelf (20). The air intake (23) is preferably located at the bottom of the shelf space, and the outlet (25) is preferably located directly behind the intake on the opposite side of the rack from the intake (23).

Further according to be preferred embodiment, the intake of an upper shelf is located at the same height position as the outlet of the shelf immediately below that shelf, as shown. An air flow diverter (24) provides a mechanical separation between opposing intake and outlet portals. A lower fan assembly (26) is preferably located just above the air flow diverter (24), which directs air flow in through the intake (23), generally upward through the shelf and across the installed blades, through a second (upper) fan assembly (26′), and out through the outlet (25) of the shelf immediately above. In the case of the topmost shelf in a rack, the air flow exits out the top of the rack. The two fan assemblies (26 and 26′) provide for redundant cooling capabilities in case the performance of one of the fan assemblies is degraded.

This mechanical structure allows for more compact and efficient use of the vertical space of the rack. Additionally, this air flow direction and diversion provides for limitation of flame spread in upward direction from one shelf to the shelf immediately above it.

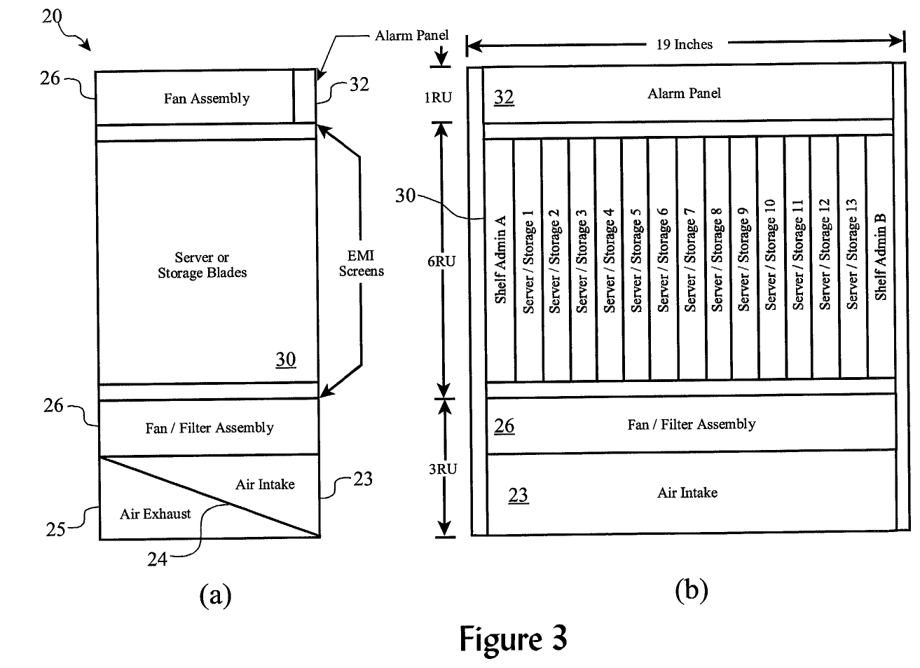

Turning to FIGS. 3a and 3b, a more detailed depiction of the mechanical and physical arrangement of the shelf components is given. As shown in FIG. 3a which is taken from a side view, each shelf (20) provides an air intake (23), an air outlet (25), an air diverter (24), and a fan and filter assemblies (26 and 26), as previously described.

According to the preferred embodiment, each shelf is also provided with an alarm panel (32) mounted on the front side, as shown.

A number of slots for electronic circuit cards or “blades” (30) are provided in each shelf (20). Referring now to FIG. 3b which is taken from a front perspective of the shelf (20), the blade slots (30) are ranged as a series of vertical card slots arranged in a single horizontal row. Within these blade slots (30) a number of server and storage modules or blades may be installed. Each shelf is capable of receiving two shelf administration blades, and up to 13 server and/or storage blades in any combination as described infra.

Further according to the preferred embodiment, the total height of the shelf (20) is 10 RU, with 1 RU provided for the alarm panel (32), 3 RU provided for the air intake (23) and fan lower assembly (26), leaving 6 RU for the height of the shelf administration blades, server blades, and storage blades.

Shelf Functional Organization—Electronic and Software

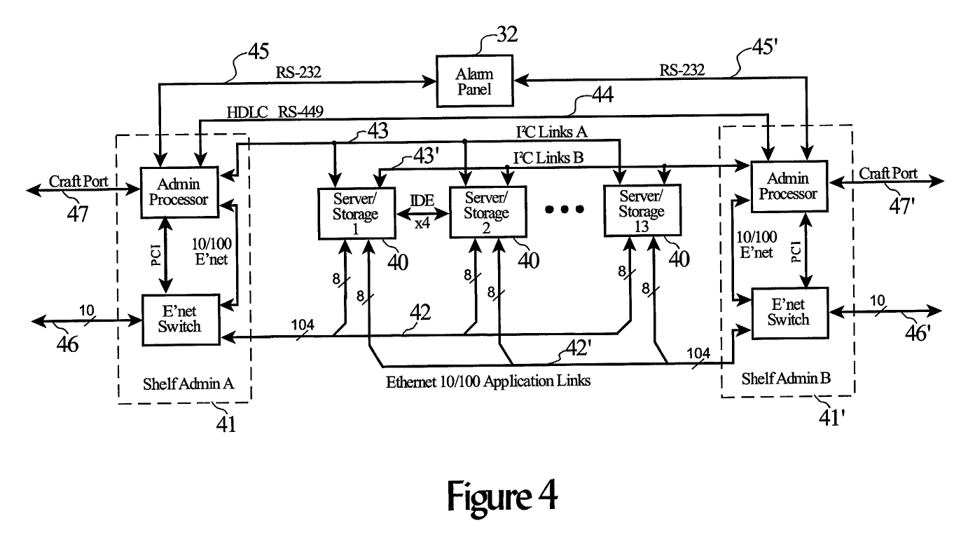

Turning now to FIG. 4, the architecture of an ISAP shelf (20) is shown in detail. A number of server blades and storage blades (40) disposed in the shelf slots (30), as previously described, are communicably interconnected by a switched backplane in a symmetric arrangement with two shelf administration blades A and B (41 and 41′) via two types of data bus.

The first type of data bus is a set of high-speed serial data communication buses (42 and 42′) which provide data communication paths between each server or storage blade (40) and each switch on the shelf administration blades (41). According to the preferred embodiment, the total of 104 Ethernet 10/100 links (42) (13 server/storage blades*8 links per blade) are provided between the switch on shelf administration module A (41) and the server/storage blades (40). Each server/storage blade (40) may transceive 8 of these lins to send and receive data to and from shelf administration module A (41).

Likewise in a symmetrical manner, 104 links (42′) are provided between the switch on shelf administration module B (41′) and the server/storage blades (40), such that 100% redundancy for data communications between shelf administration modules and the server/storage blades is provided.

Further according to the preferred embodiment, each shelf administration module is interconnected to each server/storage blade via an I²C Link for low bandwidth communication functions such as status monitoring and maintenance commands.

According to the preferred embodiment, adjacent pairs of blade slots are provided with four common disk drive interfaces (500), such as IDE, to allow pairs comprising a processor blade and a storage blade to be installed adjacent to each other and to have direct data connectivity with each other. This allows tighter integration of storage and processing functions for these pairs of blades, as well as allows for interfacing to a less sophisticated storage blades (e.g. non-Ethernet capable). The adjacent slot interfaces (500) are provided between odd-even blade slots combinations, such as 1 and 2, 3 and 4, 5 and 6, but not between even-odd blade slot pairs, such as 2 and 3, or 4 and 5.

Two shelf administration modules (41 and 41′) are also provided with direct communications to each other via a lower data rate serial communication path (44) such as an RS-449 link running HDLC. This allows the backup or redundant shelf administration module (41′) to communicate with the primary shelf administration module (41) in order to poll or monitor for potential errors and problems, and to constantly update a copy of the context and configuration of the shelf

Each shelf administration module is also provided with a serial data communications link (45) such as an RS-232 link to the alarm panel (32). Each shelf administration module is also provided with a plurality of high-speed data links (46 and 46′) for external connection to shelf such as ten 1-Gigabit Ethernet links, as shown.

Also according to the preferred embodiment, each shelf administration module provides a craft port (47 and 47′) for local access to be shelf administration functions by support personnel. Craft ports and their usage are well-known in the arts of telecommunications switches, but are not usually provided on network computing platforms such as Internet servers.

The mechanical and electrical design of the backplane and blade slots is preferably adapted for hot swapping of blades in order to avoid the need to power down an entire shelf in order to just replace or change out one blade. In the preferred embodiment, a common type of hot swappable connector is used such as that used in VME and Compact PCI (cPCI) backplanes.

Server Blade Architecture

The Server Blades preferably are provided with four Motorola PowerPC [TM] G4 processors (G4), such as Motorola's model MPC7410 or equivalent. This processor includes built-in signal processing acceleration functions and hardware, referred to as Altivec [TM]. Other processors of similar class of processing power have such acceleration hardware including the Intel Pentium [TM] with it MMX functions. Processors such as these are well-known in the art, and it will be readily apparent to those skilled in the art that alternate processors may be employed on the server blade without departing from the spirit and scope of the present invention.

With the built-in signal processing acceleration hardware associated with the processor, the architecture assumes an organization of having hardware accelerated signal processing capabilities distributed to each processor on each server blade where it is co-located with the application program which might need hardware acceleration functions. Such applications include voice navigation of Web pages and applications including the requirement to perform voice recognition, wireless application protocol (WAP) applications, security applications such as secure sockets layer (SSL), and multimedia applications such as compression technologies (LZ, DCT, Wavelet, MPEG, etc.).

The processors preferably are executing a well-known open source operating system such as Linux, but may alternately execute other operating systems such as Microsoft's Windows [TM], Unix, or other suitable operating system.

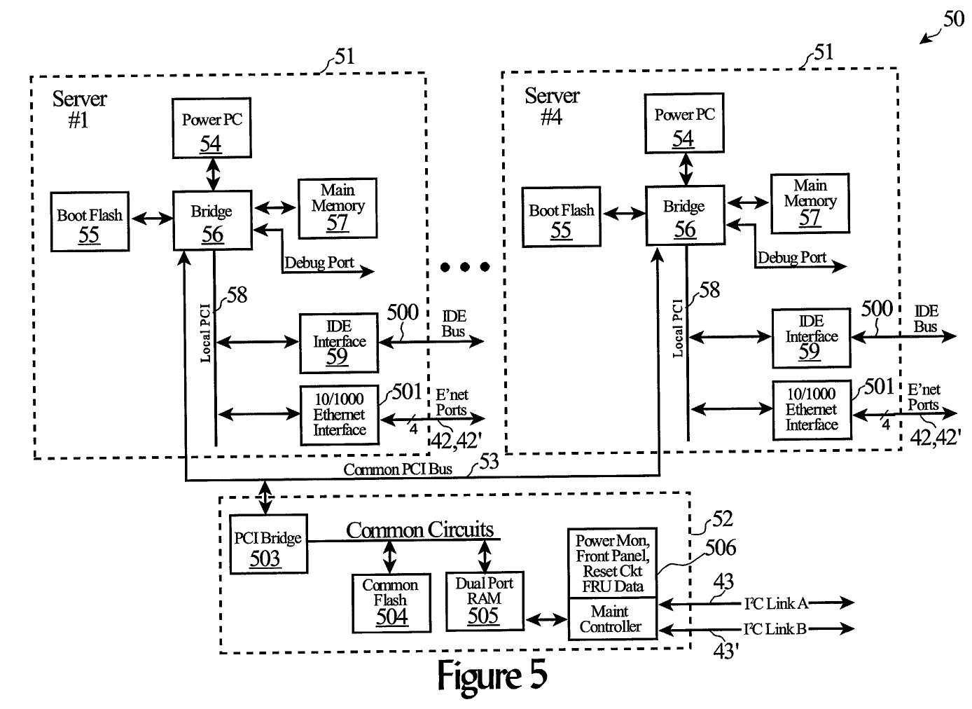

Turning to FIG. 5, details of the server module architecture are given. Each server module (50) preferably contains four server cores (51) and a common circuit complex (52). Each server core (51) is provided with one or more microprocessors (54), such as the Motorola G4 [TM] with Altivec hardware accelerator functions, coupled to main local memory (57) such as SDRAM with ECC, and persistent local memory for booting (55) the processor such as FlashROM through an appropriate bridge device (56).

According to the preferred embodiment using the Motorola G4 [TM] processor, the companion bridge device (56) also provides connectivity to a debug system. The companion bridge (56) also provides a local PCI bus (58) which is interfaced to a high-speed data communications interface (501) such as a 10/100 Ethernet Interface (501), which in turn interfaces to the high-speed data communication buses (42, 42′) across the backplane to the shelf administration modules as previously described.

Also interfaced to the local PCI bus (58) in each server core (51) is a local parallel interface (59) such as an IDE interface for direct communication through the backplane to an adjacent slot which may house a storage blade.

Also provided by the companion bridge (56) is an interface to a server module common PCI bus (53) to which all server cores (51) are interfaced, as well as to which the common circuit complex (52) is interfaced. This provides a communication path between the server cores and the common circuit complex.

Turning to the common circuit complex (52), a common non-volatile memory resource (504) such as FlashROM is provided as well as the dual-port RAM resource (505), both of which are interfaced to the common PCI bus (53) via a PCI bridge device (503). The other port of the dual-port RAM resource (505) is interfaced to a maintenance controller, such a Hitachi HD64F212BVTF10 microprocessor, which itself interfaces to the two I²C buses (43, 43′) to the shelf administration modules and various maintenance circuits (506) such as power monitor circuits, front panel indicators and switches, a reset circuit, and storage for field replaceable unit (FRU) data such as serial numbers, maintenance history, error logs, etc.

Table 2 shows the specific manufacturer and part numbers according to the preferred embodiment for realization of the server blade (50) based on a Motorola G4 [TM] processor. It will be readily recognized by those skilled in the art that components with corresponding functionality may be obtained and employed in order to base the invention on an alternate microprocessor without departing from the spirit and scope of invention.

TABLE 2
Electronic Components of the Preferred Embodiment

| Description | Manufacturer | Part Number/Name |
|---|---|---|
| Bridge (56) | Galileo | GT-64260-B-9-C100-00 |
| IDE Interface (59) | Highpoint | HPT370 |
| 10/100 Ethernet I/F (501) | Galileo/Marvell | GT-48370-B-X |
| PCI Bridge (503) | PLX | PCI9030-AA60B1 |
| Maintenance Controller (506) | Hitachi | HD64F212BVTF10 |
| Processor (54) | Motorola | PowerPC G4 |

Administration Module Architecture

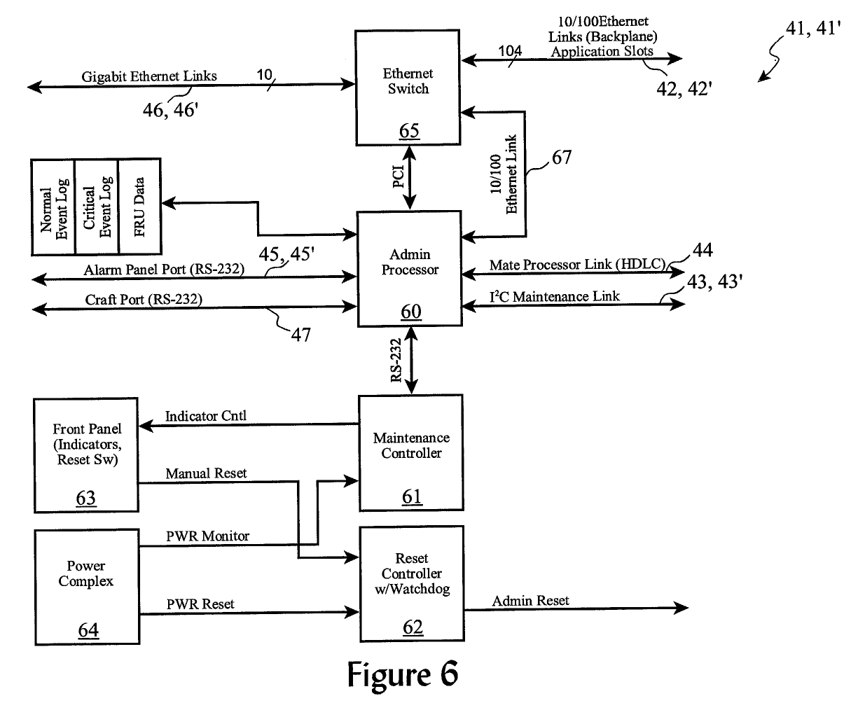

Turning to FIG. 6, details of the architecture of the administration module (41, 41′) are shown. At the heart of administration module is the administration processor (60), which according to the preferred embodiment is a Motorola PowerQUICC MPC860. This processor directly interfaces to the server and storage blades via the the I²C maintenance links (43, 43′), as well as to the craft port serial link (47) and the alarm panel serial link (45, 45′), all of which have been previously described.

Further, the administration module (41, 41′) is provided with a shelf maintenance controller (61), such as the aforementioned Hitachi microprocessor, which is interfaced to the front panel components (63), the power complex (64), and drives an administration reset signal using a reset controller (62).

The administration module reset signal preferably resets circuits on the administration module only. The signal may be initiated by a manual reset switch on the front panel, or by the power circuits (power on, etc.). The administration module may also reset other devices such as server blades and storage blades via the I²C maintenance links.

Shelf temperature monitoring and fan performance monitoring are provided by the alarm panel (32). The administration module administration processor (60) accesses such status via the RS-232 link connection to alarm panel.

The administration processor (60) and the shelf maintenance controller (61) may be interfaced to each other through a common method such as through a serial port, shared memory location, or other scheme.

The administration processor (60) also interfaces to local memory in which maintenance data (66) such as an event log, critical event log, and field replaceable unit (“FRU”) data may be stored.

The administration module (41, 41′) is also provided with an Ethernet Switch (65) for interconnecting the server blades, storage blades, administration processor (60), and external networks.

Ethernet Switch Construction

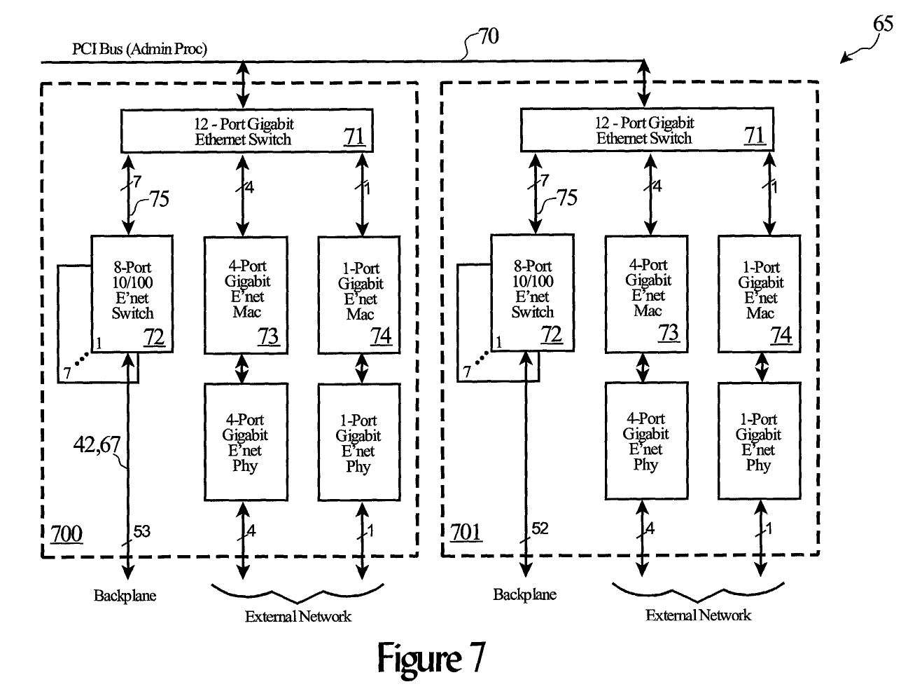

Turning to FIG. 7, details of the preferred embodiment of the administration module's Ethernet switch (65) are given. The administration module ethernet switch (65) contains two switch partitions (700, 701). Each partition is implemented using a 12-port Gigabit Ethernet switch component (71). Within each partition, seven 1-Gigabit ports (75) are used for access to backplane connected 10/100 Ethernet ports (72). Each of the seven 1-Gigabit ports (75) connects eight 10/100 ports through an 8-port 10/100 Ethernet switch (72) with integrated MAC/PHY devices.

The first switch partition (700) provides 53 of the possible 56 ports are interconnected via the backplane, 52 of these routed to server and storage blade slots, and one routed for host access. The second switch partition (701) provides fifty-two 10/100 Ethernet ports to server and storage blade slots.

In each partition, five remaining 1-Gigabit ports from the 12-port Gigibit Ethernet Switches (71) are used for connecting Gigabit links to the external network via a 4-port and a 1-port Gigabit Ethernet chipset (73, 74).

A PCI bus (70) from the switch elements (71) to the administration processor provides a communication path for the administration processor to configure the switch elements and to collect switch statistics.

Alternate assemblies using these components can be made to increase or decrease the number of Ethernet links provided depending on the anticipated demands of the application programs.

Storage Blade Architecture

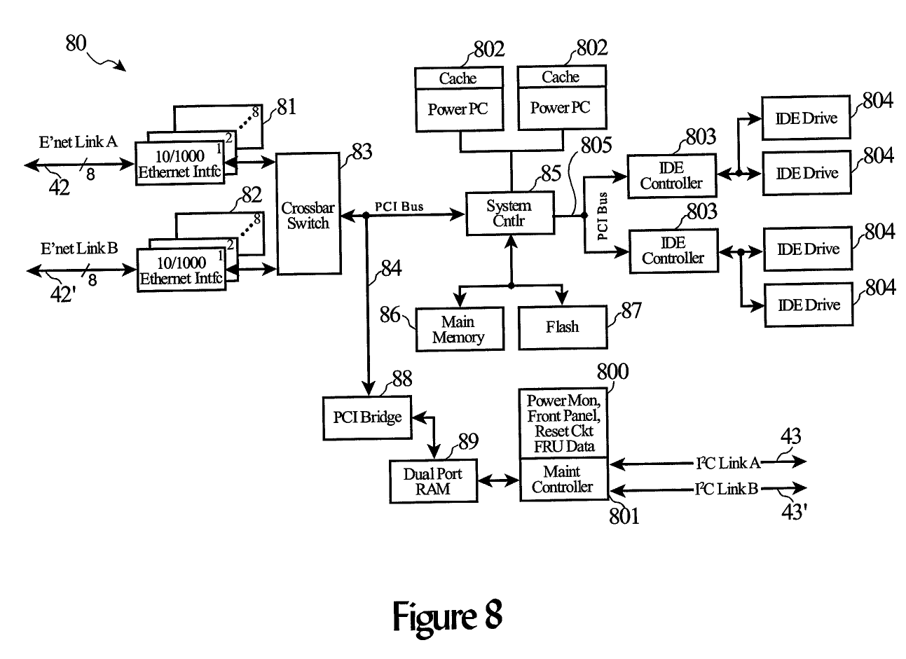

Turning to FIG. 8, the design of the storage blade (80) according to the preferred embodiment is shown in block diagram form. In this configuration, data is received for storage and retrieved from storage via the Ethernet links (42, 42′). A pair of processors (802) provide administration and storage protocol processing (e.g. SCSI over IP). A maintenance controller (801) provides low level maintenance functions, including power monitoring, local and remote blade reset (800), and maintenance connections to redundant administration modules via the I²C Links A and B (43, 43′).

In this embodiment, the storage module (80) has four IDE hard drives, typically 40 Gb per drive. The module's two processors (802) operate in symmetrical multiprocessing (“SMP”) mode for protocol processing, and are interfaced to main memory (86), flash memory (87) and two PCI Buses via a system controller (85).

One PCI Bus (84) connects Ethernet Ports (42, 42′) via a crossbar switch (83) and two 10/100 Ethernet interfaces (81, 82). The onboard Maintenance Controller (801) is interfaced to the system controller (85) via a PCI Bridge (88) and dual port RAM (89).

A second PCI Bus (805) connects two IDE Controllers (803) that provide access to two IDE hard drives each for a total of 4 drives (804) on the blade assembly.

Summary

As certain details of the preferred embodiment have been described, and particular examples presented for illustration, it will be recognized by those skilled in the art that many substitutions and variations may be made from the disclosed embodiments and details without departing from the spirit and scope of the invention. For example, the emerging InfiniBand data communications and switching technology may be employed either as a replacement for or in addition to the Ethernet backplane buses.

InfiniBand is a merged solution representing features and techniques from the Future I/O bus (Compaq, IBM, Hewlett-Packard) and the Next Generation I/O bus (Intel, Microsoft, Sun Microsystems). It is a high-speed serial bus which runs the Internet Protocol with packetized data. The bus itself can also be viewed as a switch, given its addressing capabilities and multicasting abilities. As such, the data paths on the backplane of the preferred embodiment could be replaced by or augmented by InfiniBand buses, with the appropriate substitution or addition of Infi and switches to the administration modules in the place or in addition to the Ethernet switches.

In yet another example of a variation in the disclosed preferred embodiment which would fall within the scope of the present invention would be the use alternate microprocessor devices and companion chipset devices which may be employed to achieve the functionality and organization of the invention. Therefore, the scope of the invention should be determined by the following claims.

What is claimed is:

1. An Internet server appliance platform for providing a configurable integrated suite of processing resources and content delivery capabilities supporting continuous data flow demands as well as bursty demands, said server platform comprising:
at least one administration module having a first external network interface, a first internal network interface, a first administration processor, and a first data switch, said first data switch providing data switching between said first internal and first external networks, to and from said first administration processor;
a plurality of blade devices communicably interconnected to said first data switch via said first internal network, each blade device adapted to exclusively provide either processing functionality or storage functionality thereby enabling a flexible ratio of processing-to-storage units to be realized in a system configuration; and
at least one administration link disposed between said first administration processor and said blade devices for support of software control, configuration and maintenance operations.

2. The system as set forth in claim 1 wherein said first data switch comprises an Ethernet switch and said first internal network is an Ethernet bus.

3. The system as set forth in claim 1 wherein said first data switch comprises an InfiniBand switch and said first internal network is an InfiniBand bus.

4. The system as set forth in claim 1 wherein each blade which provides exclusively processing functionality is adapted to provide signal processing functionality coupled with general purpose processing functionality.

6. The system as set forth in claim 1 wherein said administration link comprises an I²C link.

7. The system as set forth in claim 1 further comprising a local data storage bus disposed between pairs of said blades such that each blade is interfaced to only one other blade thereby providing for direct communications between processing blades and storage blades.

8. The system as set forth in claim 1 further comprising:
a second, redundant administration module having a second external network interface, a second internal network interface, a second administration module, and a second data switch, said second data switch providing data switching between said second internal and second external networks, to and from said second administration processor;
a plurality of blade devices communicably interconnected to said first data switch via said first internal network, and further communicably interconnected to said second data switch via said second internal network, each blade device adapted to exclusively provide either processing functionality or storage functionality thereby enabling a flexible ratio of processing-to-storage units to be realized in a system configuration; and at least one additional administration link disposed between said second administration processor and said blade devices for support of software control, configuration and maintenance operations.

9. A method for providing an Internet server appliance platform having a configurable integrated suite of processing resources and content delivery capabilities for supporting applications with continuous data flow demands as well as bursty demands, said method comprising the steps of:
providing at least one administration module having a first external network interface, a first internal network interface, a first administration processor, and a first data switch, said first data switch performing data switching between said first internal and first external networks, to and from said first administration processor;
providing a plurality of blade devices communicably interconnected to said first data switch via said first internal network, each blade device being adapted to exclusively provide either processing functionality or storage functionality thereby enabling a flexible ratio of processing-to-storage units to be realized in a system configuration; and
providing at least one administration link disposed between said first administration processor and said blade devices for support of software control, configuration and maintenance operations.

10. The method as set forth in claim 9 wherein said step of providing a first data switch comprises providing an Ethernet switch, and wherein said step of providing a first internal network comprises providing an Ethernet bus.

11. The method as set forth in claim 9 wherein said step of providing a first data switch comprises providing an InfiniBand switch, and wherein said step of providing a first internal network comprises providing an InfiniBand bus.

12. The method as set forth in claim 9 wherein said step of providing a plurality of blade devices comprises providing blade devices which are adapted to execute signal processing software on digital signal microprocessor hardware coupled with executing general purpose software on general purpose microprocessing hardware.

13. The method as set forth in claim 9 wherein said step of providing an administration link comprises providing an I²C link.

14. The method as set forth in claim 9 further comprising the step of providing a plurality of local data storage buses disposed between pairs of said blades such that each blade is interfaced to one and only one other blade, thereby allowing a direct data communications between processing blades and storage blades.

15. The method as set forth in claim 9 further comprising the steps of:
providing a second, redundant administration module having a second external network interface, a second internal network interface, a second administration module, and a second data switch, said second data switch providing data switching between said second internal and second external networks, to and from said second administration processor;
providing a plurality of blade devices communicably interconnected to said first data switch via said first internal network, and further communicably interconnected to said second data switch via said second internal network, each blade device adapted to exclusively provide either processing functionality or storage functionality thereby enabling a flexible ratio of processing-to-storage units to be realized in a system configuration; and
providing at least one additional administration link disposed between said second administration processor and said blade devices for support of software control, configuration and maintenance operations.
